(19) United States
(12) Patent Application Publication
(10) Pub. No.: US 2026/0186549 A1
(43) Pub. Date: Jul. 2, 2026

(54) DEVICE AND POWER CONTROL METHOD AND APPARATUS FOR DEVICE

(71) Applicant: GOERTEK TECHNOLOGY CO., LTD, Qingdao, Shandong (CN)

(72) Inventor: Xiaoyan FAN, Qingdao, Shandong (CN)

(21) Appl. No.: 18/847,348

(22) PCT Filed: Jun. 30, 2022
(86) PCT No.: PCT/CN2022/102768

§ 371 Date: Sep. 16, 2024

(30) Foreign Application Priority Data
Apr. 25, 2022 (CN) 202210438780.2

(51) Int. Cl. G06F 1/3231; G06F 1/16; G06F 1/3234; G06F 3/01

(52) U.S. Cl. CPC G06F 1/3231; G06F 1/163; G06F 1/1698; G06F 1/325; G06F 3/011

(57) ABSTRACT

The disclosure discloses a power control method, system and apparatus for a device, and relates to a field of power control. If it is determined that the device is carried by a user, obtaining a current state mode of the user, which at least comprises sleep and non-sleep modes, and then adjusting a power upper limit of a RFFE module in the device to a power upper limit corresponding to the current state mode of the user, a power upper limit in the non-sleep mode is greater than that in the sleep mode. The power upper limit of the RFFE module in the device can be adjusted to applicable to the power upper limit in different state modes of the user, for avoiding excessively high power of the RFFE module, avoiding discomfort to the user caused by heating of the device and the influence of radiation on the health of the user.

The present application claims priority to a Chinese patent application No. 202210438780.2, entitled “POWER CONTROL METHOD, SYSTEM AND APPARATUS FOR DEVICE”, filed with the China Patent Office on Apr. 25, 2022, the entire contents of which are combined by reference in the present application.

### TECHNICAL FIELD

The present disclosure relates to a field of power control, and in particular to a power control method, system and apparatus for a device.

### BACKGROUND

A Long Term Evolution (LTE) communication device such as a mobile phone and a watch is provided with a Radio Frequency Front-End (RFFE) module therein. The RFFE module is related to transmission and reception of a radio frequency signal of the device, and an operation power of the RFFE module may be changed according to a strength of a signal received by the device currently. The lower the strength of the signal, the higher the operation power, and the higher the strength of the signal, the lower the operation power, so as to enhance quality of the signal received by the device and ensure use experience of the user. However, if the device is in an environment with a low strength of the signal, the operation power of the RFFE module may be excessively high. An excessive operation power will cause the heating of the device and generate a large radiation, and the heating of the device will cause discomfort to the user, and the large radiation will affect the health of the user.

### SUMMARY

An object of the present disclosure is to provide a power control method, system and apparatus for a device, a power upper limit of a RFFE module in the device can be adjusted to applicable to a power upper limit in different state modes of the user, for avoiding excessively high power of the RFFE module, thereby avoiding the discomfort to the user caused by the heating of the device and the effect of the radiation on the health of the user.

In order to solve the above technical problems, the present disclosure provides a power control method for a device, comprising:
if it is determined that the device is carried by a user, determining a current state mode of the user, wherein the state mode at least comprises a sleep mode and a non-sleep mode; and
adjusting a power upper limit of a RFFE module in the device to a power upper limit corresponding to the state mode, wherein a power upper limit corresponding to the sleep mode is less than a power upper limit corresponding to the non-sleep mode.

Preferably, the determining the current state mode of the user includes:
determining the current state mode of the user according to one or more of a heart rate value, a blood pressure value and ECG information of the user obtained within a first preset time period.

Preferably, the determining the current state mode of the user includes:
obtaining an acceleration value detected by an acceleration sensor in the device within a second preset time period;
determining a body posture of the user according to the acceleration value; and
determining the current state mode of the user according to the body posture.

Preferably, before the determining the current state mode of the user, the method further includes:
determining whether the device is carried by the user;
if the device is carried by the user, proceeding to the determining the current state mode of the user; and
if the device is not carried by the user, adjusting the power upper limit of the RFFE module in the device to a first preset power upper limit which is greater than the power upper limit corresponding to the sleep mode.

Preferably, the determining whether the device is carried by the user includes:
determining whether a heart rate value obtained within a third preset time period is less than a preset heart rate value;
if yes, determining that the device is not carried by the user; and
if not, determining that the device is carried by the user.

Preferably, the power upper limit of the RFFE module in the device is a power upper limit of a PA unit in the RFFE module in the device.

Preferably, if the non-sleep mode is a call mode, the adjusting the power upper limit of the RFFE module in the device to the power upper limit corresponding to the state mode includes:
adjusting the power upper limit of the RFFE module in the device according to a distance between the device and a head of the user, wherein the power upper limit is positively correlated with the distance.

Preferably, before the adjusting the power upper limit of the RFFE module in the device according to the distance between the device and the head of the user, the method includes:
determining whether the user has a wrist-raising action based on an acceleration sensor in the device;
if yes, proceeding to the adjusting the power upper limit of the RFFE module in the device according to the distance between the device and head of the user; and
if not, adjusting the power upper limit of the RFFE module in the device to a second preset power upper limit which is greater than the power upper limit corresponding to the sleep mode.

The present disclosure further provides a power control apparatus for a device, the power control apparatus comprising:
a memory configured to store a computer program; and
a processor configured to implement steps of the above power control method for the device when executing the computer program.

The present disclosure further provides a device, including an RFFE module, and further comprising the above power control apparatus for the device,
wherein the RFFE module is connected to the power control apparatus for the device in sequence.

The present disclosure discloses a power control method, system and apparatus for a device. The method comprises: if it is determined that the device is carried by a user, first obtaining a current state mode of the user, wherein the state mode at least comprises a sleep mode and a non-sleep mode, and then adjusting a power upper limit of a RFFE module in the device to a power upper limit corresponding to the current state mode of the user, wherein a power upper limit in the non-sleep mode is greater than a power upper limit in the sleep mode. On this basis, the power upper limit of the RFFE module in the device can be adjusted to applicable to the power upper limit in different state modes of the user, for avoiding excessively high power of the RFFE module, thereby avoiding discomfort to the user caused by the heating of the device to the user and the effect of the radiation on the health of the user.

### BRIEF DESCRIPTION OF DRAWINGS

In order to more clearly illustrate the technical solutions in the embodiments of the present disclosure, the drawings required for use in the related art and the embodiments are briefly introduced below. Obviously, the drawings described below are only some embodiments of the present disclosure. For those skilled in the art, other drawings can be obtained based on these drawings without creative work.

FIG. 1 is a flow chart of a power control method for a device provided by the present disclosure;

FIG. 2 is a flow chart of another power control method for a device provided by the present disclosure;

FIG. 3 is a flow chart of another power control method for a device provided by the present disclosure;

FIG. 4 is a schematic diagram of the structure of a power control apparatus for a device provided by the present disclosure; and

FIG. 5 is a schematic diagram of the structure of a device provided by the present disclosure.

### DETAILED DESCRIPTIONS

The core of the present disclosure is to provide a power control method, system and device for a device, the power upper limit of the RFFE module in the device can be adjusted to applicable to the power upper limit in different state modes of the user, for avoiding excessively power of the RFFE module, thereby avoiding discomfort to the user caused by the heating of the device to the user and the effect of the radiation on the health of the user.

In order to make the purpose, technical solution and advantages of the embodiments of the present disclosure clearer, the technical solution in the embodiments of the present disclosure will be clearly and completely described below in conjunction with the drawings in the embodiments of the present disclosure. Obviously, the described embodiments are part of the embodiments of the present disclosure, not all of the embodiments. Based on the embodiments of the present disclosure, all other embodiments obtained by those skilled in the art without creative work are within the scope of protection of the present disclosure.

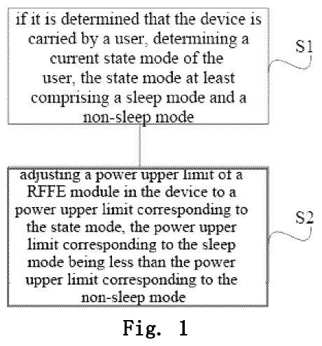

Please refer to FIG. 1, which is a flow chart of a power control method for a device provided in the present disclosure, including:
S1: if it is determined that the device is carried by the user, determining the current state mode of the user, wherein the state mode at least includes a sleep mode and a non-sleep mode;
S2: adjusting the power upper limit of the RFFE module in the device to the power upper limit corresponding to the state mode, wherein a power upper limit corresponding to the sleep mode is smaller than a power upper limit corresponding to the non-sleep mode.

Considering that the user can withstand different heat and radiation of the device in different states, for example, the resistance of the body of the user will be decreased in a sleeping state, and the health of the user is easily affected by the radiation. In addition, the heating of the device will also cause discomfort to the user. In order to avoid the discomfort caused by the heating of the device to the user and the effect of the radiation on the health of the user, after the user carries the device, the current state mode of the user is determined, and the state mode includes at least the sleep mode and the non-sleep mode. The non-sleep mode may be, but is not limited to, a call mode in which the user is on a call or other modes.

The RFFE module is one of the core modules in the device. The power of the RFFE module is positively correlated with the heat and the radiation of the device. By adjusting the power upper limit of the RFFE module, the maximum power that can be generated by the RFFE module is limited, thereby avoiding the effect of the heating and the radiation of the device on the user. Specifically, different state modes correspond to different power upper limits. If the state mode is the sleep mode or a state indicating that the user is more susceptible to the heating and the radiation, the corresponding power upper limit is lower. If the state mode is the non-sleep mode, the corresponding power upper limit is higher than that of the sleep mode, to ensure the experience of the user during a normal use.

To summarize, if it is determined that the user carries the device, the current state mode of the user is first obtained, wherein the state mode at least comprises the sleep mode and the non-sleep mode, and then the power upper limit of the device is adjusted to the power upper limit corresponding to the current state mode of the user. The power upper limit in the non-sleep mode is greater than the power upper limit in the sleep mode. On this basis, the power upper limit of the device can be adjusted to applicable to the power upper limit in different state modes of the user, for avoiding excessively high power generated by the device, thereby avoiding the discomfort to the user caused by the heating of the device and the effect of radiation on the health of the user.

Based on the above embodiments:

As a preferred embodiment, the determining the current state mode of the user includes:
determining the current state mode of the user according to one or more of the user's heart rate value, blood pressure value and ECG information obtained within the first preset time period.

In order to determine the current state mode of the user, in the present disclosure, since the corresponding heart rate value, blood pressure value and ECG (electrocardiogram) information of the user are different if the user is in different state modes, for example, the heart rate value and the blood pressure value of the user in the sleep mode are lower, and the ECG waveform fluctuation is smaller, while the heart rate value and the blood pressure value of the user in an exercise mode are lower, and the ECG waveform fluctuation is larger. It can be seen that there is a corresponding relationship between the heart rate value, the blood pressure value and the ECG information and the current state mode of the user. When obtaining the information, the information detected by the biosensor in the device can be obtained, but not limited thereto. In addition, the first preset time period may be a period of time with the current time as the end time point. By obtaining the heart rate value, the blood pressure value and the ECG information of the user within the first preset time period, the current state mode of the user can be accurately determined.

As a preferred embodiment, determining the current state mode of the user includes:
obtaining the acceleration value detected by the acceleration sensor in the device within a second preset time period;
determining the user's body posture based on the acceleration value; and
determining the user's current state mode based on the body posture.

In order to determine the current state mode of the user, in the present disclosure, different actions and postures of the user correspond to different state modes. For example, if the user carries the device on the wrist, the position change range of the device is small if the user is lying flat, the detected acceleration value is lower, and the frequency of change of the acceleration value may be lower; while if the user is sitting upright, the position of the device usually changes horizontally, and the direction of the detected acceleration value is usually approximately parallel to the ground. It can be seen that there is a corresponding relationship between the detected acceleration value and the current state mode of the user. Based on this, the body posture of the user may be determined by the acceleration value detected within the second preset time period, and the state mode may be determined by the body state, so that the current state mode of the user may be accurately determined.

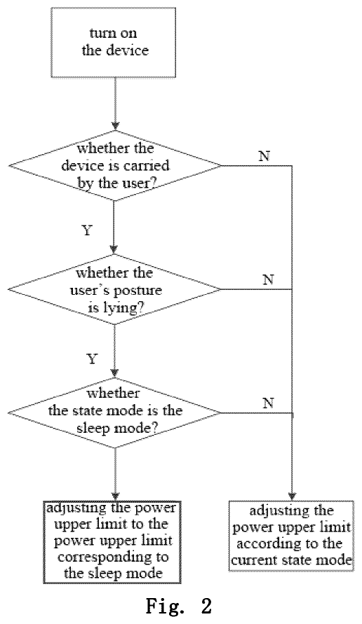

In addition, in order to further improve the accuracy of determining the state mode, the body posture of the user may be first determined by the acceleration value, and then the heart rate value, the blood pressure value and the ECG information of the user may be obtained. The current state mode of the user may be determined by combining the both. Please refer to FIG. 2, which is a flow chart of a power control method of another device provided by the present disclosure. For example, considering that the user is usually lying flat when sleeping, if the user is in the lying mode is first determined by the acceleration value, the heart rate value, then whether the user is in the sleep mode is determined by the blood pressure value and the ECG information of the user. This can avoid mis-determining the state mode of the user as the sleep mode if the user is not in the lying mode, and can accurately determine the state mode of the user.

As a preferred embodiment, before determining the current state mode of the user, the method further includes:
determining whether the device is carried by the user;
if the device is carried by the user, proceeding to the step of determining the current state mode of the user; and
if the device is not carried by the user, adjusting the power upper limit of the RFFE module in the device to a first preset power upper limit which is greater than the power upper limit corresponding to the sleep mode.

In order to ensure the experience of the user, in the present disclosure, it is considered that the user may put the device beside him instead of carrying it on his body. At this time, due to the long distance between the device and the user, the heating and the radiation of the device have little impact on the user, so if the user does not carry the device, the power limit of the RFFE module in the device can be increased. Specifically, it is determined in real time or periodically whether the user carries the device according to the performance of the processor in the device. For example, it can be determined whether the user carries the device by whether the body temperature, the heart rate, and the action of the user is detected. If the user carries the device, the step of determining the current state mode of the user is performed. If the user does not carry the device, the power limit of the device is adjusted to a first preset power limit, which is greater than the power limit corresponding to the sleep mode. Since the heating and the radiation of the device have little impact on the user if the user does not carry the device, the first preset power limit may be, but not limited to, the maximum power limit of the RFFE module, to ensure the experience of the user.

As a preferred embodiment, determining whether the device is carried by the user includes:
determining whether a heart rate value obtained within the third preset time period is less than the preset heart rate value;
if yes, determining that the device is not carried by the user; and
if not, determining that the user carries a device.

In order to determine whether the user carries a device, in the present disclosure, it is considered that if the user does not carry the device, the various sensors or modules in the device cannot detect the biological information related to the user, such as the heart rate value of the user cannot be obtained; and if the user carries the device, the normal heart rate value of the user can be detected by the biosensor in the device, but it is not limited thereto. Based on this, a preset heart rate value may be set in advance. When the heart rate value detected by the biosensor within the third preset time period is obtained, it is determined whether the obtained heart rate value is less than the preset heart rate value. If it is less than the preset heart rate value, it means that the user does not carry the device, otherwise it means that the user carries the device. Considering that the heart rate value detected by the biosensor may have errors, for example, if the user does not carry the device, the heart rate value obtained should usually be zero, but at this time, the obtained heart rate value may be a single digit greater than zero. In order to avoid mis-determining this situation as the user carrying the device, the preset heart rate value may be a non-zero positive integer, to accurately determine whether the user carries the device.

As a preferred embodiment, the power upper limit of the RFFE module in the device is a power upper limit of a PA unit in the RFFE module in the device.

The Power Amplifier (PA) unit is one of the core units in the RFFE module. The PA unit can amplify the signal that the device needs to send and the signal that the device receives, so as to improve the quality of the signal received by the device. If the device is in an environment with different strengths of the signals, the quality of the signal received by the device is also different. For example, if the device is in an environment with weak strength of the signal, the quality of the signal received by the device is poor. At this time, the operation power of the device PA unit itself will be increased to improve the quality of the signal. Considering that directly adjusting the power upper limit of the entire RFFE module may affect the normal operation efficiency of other units in the RFFE module, in order to avoid affecting other units in the RFFE module, adjusting the power upper limit of the PA unit in the RFFE module controls the heat and the radiation generated by the device, and also avoids the influence on other units in the RFFE module. Moreover, in addition to the power upper limit of the PA unit, it can also be the power upper limit of the Tuner unit in the RFFE module or other units in the RFFE module related to the signal received by the device.

As a preferred embodiment, if the non-sleep mode is a call mode, adjusting the power upper limit of the RFFE module in the device to the power upper limit corresponding to the state mode includes:
adjusting the power upper limit of the RFFE module in the device according to the distance between the device and a head of the user, wherein the power upper limit is positively correlated with the distance.

In order to reduce the effect of the radiation generated by the device on the user when the user is on a call, in the present disclosure, it is taken into account that the user usually puts the device to the ear when making a call. At this time, since the distance between the device and the head of the user is relatively close, the radiation generated by the device can easily affect the health of the user. Therefore, if the user is in a call state, the power upper limit of the device is adjusted according to the distance between the device itself and the head of the user. The closer the device itself is to the head of the user, the lower the power upper limit of the device, and the farther the device itself from the head of the user, the higher the power upper limit of the device, to reduce the effect of the radiation generated by the device to the user if the user puts the device to the ear to make a call.

As a preferred embodiment, before adjusting the power upper limit of the RFFE module in the device according to the distance between the device and the head of the user, the method further includes:
determining whether the user has a wrist-raising action based on the acceleration sensor in the device;
if yes, then proceeding to the step of adjusting the power upper limit of the RFFE module in the device according to the distance between the device and the head of the user; and
If not, adjusting the power upper limit of the RFFE module in the device to a second preset power upper limit which is greater than the power upper limit corresponding to the sleep mode.

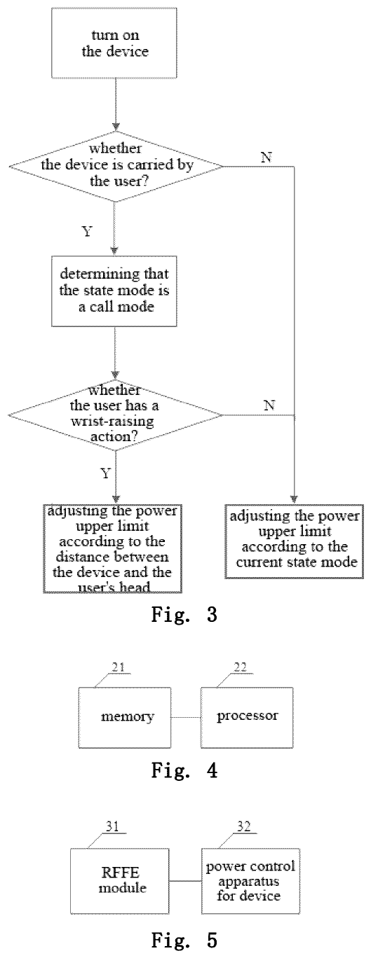

In order to determine whether the user puts the device to the ear for a call, in the present disclosure, considering that in the non-call mode, the user usually carries the device on the wrist or stores it in the clothes, when other communication devices send communication signals to the device, the user needs to pick it up for a call. It can be seen that the user needs to pick up the device before making a call, that is, the wrist-raising action. Based on this, please refer to FIG. 3, which is a flowchart of another power control method for the device provided by the present disclosure. When the user is currently in a call state, the acceleration sensor in the device is used to determine whether the user has a wrist-raising action. Specifically, it can be periodically determined whether the acceleration value detected by the acceleration sensor is sudden increases and the sudden increased value is greater than a preset value. If so, it means that the user has the wrist-raising action. At this time, the power upper limit of the RFFE module in the device is adjusted according to the distance between the device itself and the head of the user. If not, it means that the user may use earphones or hands-free to make a call. Since the device is far away from the user at this time, the heat and the radiation generated by the device have little influence on the user, so that the power upper limit of the RFFE module in the device can be adjusted to the second preset upper limit. By determining whether the user has a wrist-raising action, it is possible to accurately determine whether the user has placed the device to his ear for a call.

Please refer to FIG. 4, which is a schematic diagram of a structure of a power control apparatus for a device provided by the present application, including:
a memory 21 configured to store a computer program; and
a processor 22 configured to implement the steps of the power control method for the device as described above when executing the computer program.

For a detailed introduction to the power control apparatus for a device provided in the present application, please refer to the embodiment of the power control method of the above-mentioned device, and the present application will not duplicate it again.

Please refer to FIG. 5, which is a schematic diagram of the structure of a device provided by the present application, including an RFFE module 31 and the power control apparatus 32 of the device as described above,
wherein the RFFE module 31 is connected to the power control apparatus 32 for the device in sequence.

For a detailed introduction of a device provided in the present application, please refer to the embodiment of the power control method of the above-mentioned device, and the present application will not duplicate it again.

In this specification, each embodiment is described in a progressive manner, and each embodiment focuses on the differences from other embodiments. The same or similar parts between the embodiments can be referred to each other. For the device disclosed in the embodiment, since it corresponds to the method disclosed in the embodiment, the description is relatively simple, and the relevant parts can be referred to the method part.

It should also be noted that, in this specification, relational terms such as first and second, etc. are only used to distinguish one entity or operation from another entity or operation, and do not necessarily require or imply any such actual relationship or order between these entities or operations. Moreover, the terms “comprise”, “include” or any other variants thereof are intended to cover non-exclusive inclusion, so that a process, method, article or device including a series of elements includes not only those elements, but also other elements not explicitly listed, or also includes elements inherent to such process, method, article or device. In the absence of further restrictions, an element defined by the statement “comprises a . . . ” does not exclude the presence of other identical elements in the process, method, article or device including the element.

1. A power control method for a device, comprising:
if it is determined that the device is carried by a user, determining a current state mode of the user, wherein the state mode at least comprises a sleep mode and a non-sleep mode; and
adjusting a power upper limit of a RFFE module in the device to a power upper limit corresponding to the state mode, wherein a power upper limit corresponding to the sleep mode is less than a power upper limit corresponding to the non-sleep mode.

2. The power control method for the device according to claim 1, wherein the determining the current state mode of the user comprises:
determining the current state mode of the user according to one or more of a heart rate value, a blood pressure value and ECG information of the user obtained within a first preset time period.

3. The power control method for the device according to claim 1, wherein the determining the current state mode of the user comprises:
obtaining an acceleration value detected by an acceleration sensor in the device within a second preset time period;
determining a body posture of the user according to the acceleration value; and
determining the current state mode of the user according to the body posture.

4. The power control method for the device according to claim 1, wherein before the determining the current state mode of the user, the method further comprises:
determining whether the device is carried by the user;
if the device is carried by the user, proceeding to the determining the current state mode of the user; and
if the device is not carried by the user, adjusting the power upper limit of the RFFE module in the device to a first preset power upper limit which is greater than the power upper limit corresponding to the sleep mode.

5. The power control method for the device according to claim 4, wherein the determining whether the device is carried by the user comprises:
determining whether a heart rate value obtained within a third preset time period is less than a preset heart rate value;
if yes, determining that the device is not carried by the user; and
if not, determining that the device is carried by the user.

6. The power control method for the device according to claim 1, wherein the power upper limit of the RFFE module in the device is a power upper limit of a PA unit in the RFFE module in the device.

7. The power control method for the device according to claim 1, wherein if the non-sleep mode is a call mode, the adjusting the power upper limit of the RFFE module in the device to the power upper limit corresponding to the state mode comprises:
adjusting the power upper limit of the RFFE module in the device according to a distance between the device and a head of the user, wherein the power upper limit is positively correlated with the distance.

8. The power control method for the device according to claim 7, wherein before the adjusting the power upper limit of the RFFE module in the device according to the distance between the device and the head of the user, the method further comprises:
determining whether the user has a wrist-raising action based on an acceleration sensor in the device;
if yes, proceeding to the adjusting the power upper limit of the RFFE module in the device according to the distance between the device and the head of the user; and
if not, adjusting the power upper limit of the RFFE module in the device to a second preset power upper limit which is greater than the power upper limit corresponding to the sleep mode.

9. A power control apparatus for a device, the power control apparatus comprising:
a memory configured to store a computer program; and
a processor configured to implement steps of the power control method for the device according to claim 1 when executing the computer program.

10. A device, comprising an RFFE module and the power control apparatus for the device according to claim 9,
wherein the RFFE module is connected to the power control apparatus for the device in sequence.
